(19) United States
(12) Patent Application Publication
(10) Pub. No.: US 2020/0062153 A1
(43) Pub. Date: Feb. 27, 2020

(54) SEAT FRAME FOR SECUREMENT ON A SUPPORT SURFACE

(71) Applicant: BCS Group, Pollock, LA (US)

(72) Inventor: Ronney Broussard, Pollock, LA (US)

(73) Assignee: BCS Group, Pollock, LA (US)

(21) Appl. No.: 16/548,601

(22) Filed: Aug. 22, 2019

Related U.S. Application Data
(60) Provisional application No. 62/721,120, filed on Aug. 22, 2018.

(51) Int. Cl. B60N 2/68; B60N 2/90

(52) U.S. Cl. CPC B60N 2/682; B60N 2/914

(57) ABSTRACT

A seat frame comprising a seat support member for supporting a seat, in particular a pneumatic tube or cushion, and a clamp member. The seat support member is adjustably mounted on the clamp member, and the seat frame is mountable via the clamp member on a seat frame support of a device on which at least one person can be seated.

The present invention relates to a seat frame, and in particular comprises a seat support member for supporting a seat, and a clamp member that is adjustably mounted on the seat support member; the seat frame is mountable via the clamp member on a seat frame support, such as on a seat frame post, of a device on which a person can be seated.

The main problem with previously known bicycle seats is that they are uncomfortable and cause orthopedic problems to most individuals, both male and female. Spinal pain, hemorrhoids and friction on the buttocks, thigh muscles and genitals of male and female riders are a major cause of discomfort. Conventional seats do not provide sufficient shock absorption to protect the coccyx or genitals of any rider, and can cause lasting damage to the spine and soft tissue nerves, and may cause various types of cancer.

It is therefore an object of the present invention to provide a comfortable seat so that more people can enjoy the benefits of cycling and other activities that involve sitting.

It is a further object of the present invention to provide a way to support a round rubber tube or cushion of various sizes on a bicycle seat post, motorcycle seat frame, or other device, since sitting on a round rubber tube or cushion is known to solve the pain and discomfort of many of the physical and medical issues described above.

### BRIEF DESCRIPTION OF THE DRAWINGS

FIG. 1 is a schematic side view showing a portion of a first exemplary embodiment of a seat frame of the present invention mounted on a seat post;

FIG. 2 is a schematic side viewing showing a cushioned seat member secured to the seat support member of the seat frame of FIG. 1;

FIG. 3 is a side view of one exemplary embodiment of the seat support member;

FIG. 3a is a side view of a further exemplary embodiment of the seat support member;

FIG. 3b is a side view of another exemplary embodiment of the seat support member;

FIG. 4 is a plan view of one exemplary embodiment of the seat support member;

FIG. 4a is a plan view of another exemplary embodiment of the seat support member;

FIG. 5 is a right end view of the seat support member of FIG. 4;

FIG. 6 shows the clamp member disposed on the seat post;

FIG. 6a shows a two-piece clamp member;

FIG. 7 schematically illustrates a pneumatic seat cushion and straps for securing it to the seat support member;

FIG. 8 shows a seat cushion strapped to a seat support member;

FIG. 9 is a schematic side view showing a portion of a second exemplary embodiment of a seat frame of the present invention mounted on the seat post;

FIG. 10 is a side view of another exemplary embodiment of a seat support member;

FIG. 10a is a right end view of the seat support member of FIG. 10;

FIG. 11 shows a separate disk member for a seat cushion as well as an alternative slot arrangement;

FIG. 12 shows an extended seat support member to provide a luggage rack;

FIG. 12a shows a second seat on a platform extension;

FIG. 13 is a side view of the seat support member of FIG. 12;

FIG. 14 is a plan view of the seat support member of FIG. 12;

FIG. 15 is a right end view of the seat support member of FIG. 14;

FIG. 16 is a plan view of a further exemplary embodiment of the seat support member;

FIG. 17 is a right end view of the seat support member of FIG. 16;

FIG. 18 is a side view of the seat support member of FIG. 16;

FIG. 19 is a side view showing mounting of a seat support member on a two-piece clamp member;

FIG. 20 shows slots that are provided with gear racks;

FIG. 21 shows gear bolts for engagement with the gear racks of FIG. 20; and

FIGS. 22 & 23 show a two-piece cover.

### SUMMARY OF THE INVENTION

The present invention provides a seat frame that comprises a seat support member for supporting a seat, such as the aforementioned tube or cushion, and a clamp member, wherein the seat support member is adjustably mounted on the clamp member, and wherein the seat frame is mountable via the clamp member on a seat frame support of a device on which a person can be seated. Such a frame support can be a seat post, such as for a bicycle, or some other support surface.

### DETAILED DESCRIPTION OF THE DRAWINGS

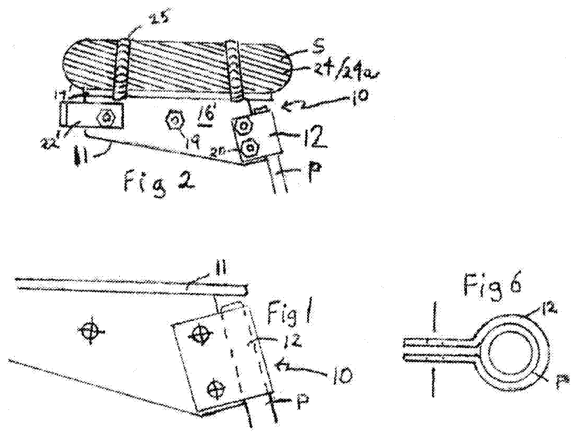

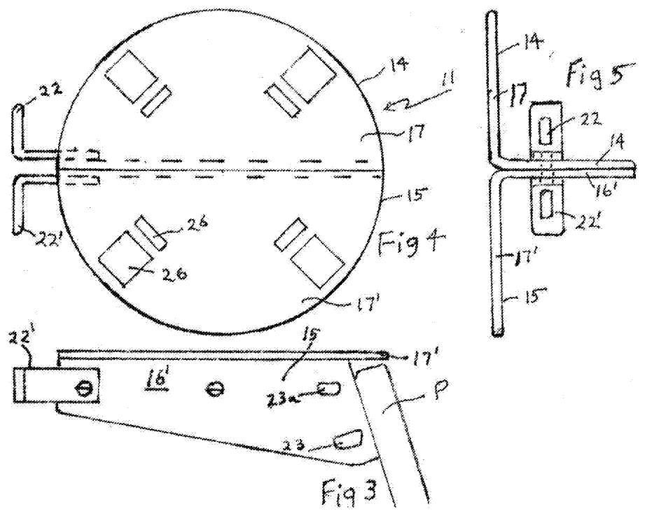

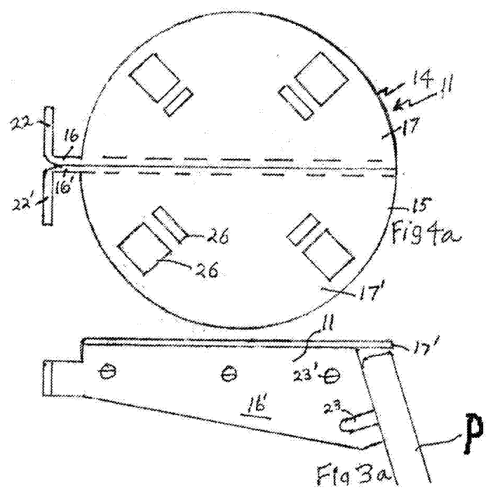

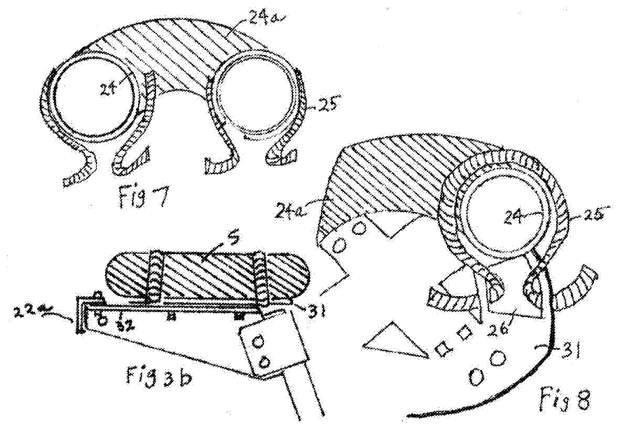

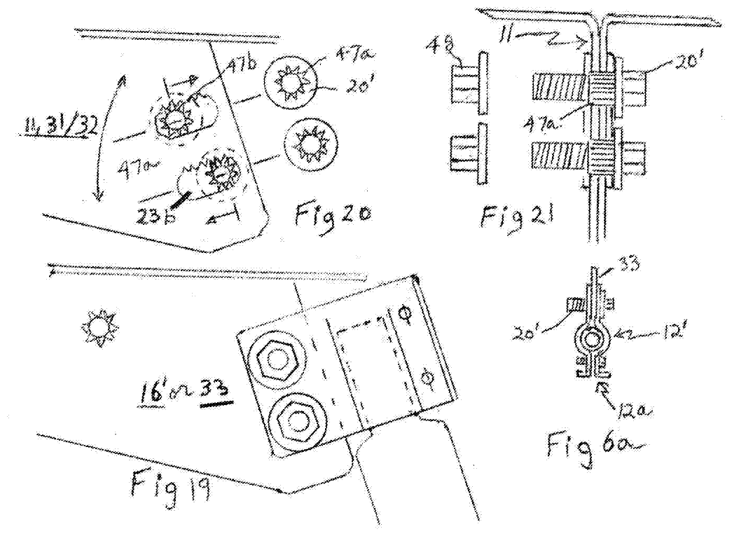

The seat frame of the present application can be used for any individual seat, but for the purposes of this detailed description, the seat frame will be shown and described in conjunction with a bicycle seat. In particular, pursuant to one exemplary embodiment, FIG. 1 shows a portion of the seat frame 10 of the present application mounted on the post P of a bicycle. FIG. 2 schematically shows a seat S, in particular in the form of a cushion member, such as a round rubber tube, disposed on the seat frame 10.

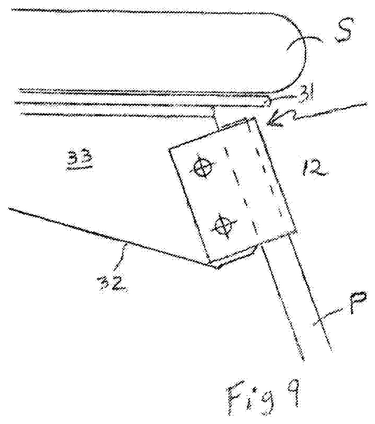

Referring now to FIGS. 1-6, the seat frame 10 of this embodiment is comprised of three parts, namely a two-part seat support member 11, and a clamp member 12 (see FIGS. 1, 2 and 6) for securing the seat frame 10 to the post P. The seat support member 11 of this embodiment comprises mating halves 14 and 15 (see in particular the plan view of FIG. 4 and the right end view of FIG. 5). The main portions of the mating halves 14 and 15 each comprise legs 16 or 16′ and 17 or 17′ respectively that are bent at right angles relative to one another such that when the legs 16 and 16′ of the halves 14 and 15 are placed together, the legs 17 and 17′ extend away from one another to form a flat surface for supporting the seat S, as shown in FIG. 2. In particular, the legs 17 and 17′, when extending away from one another, are preferably in the shape of a round disk, as can be seen in FIG. 4, to which the seat S is secured, as will be described in detail subsequently.

As shown in particular in FIG. 2, the two legs 16 and 16′ of the two mating halves 14 and 15 are secured to one another to form the seat support member 11. Such securement can be by any appropriate means 19, including bolts and nuts. As indicated above, when the mating halves are properly secured to one another, the angled-off legs 17 and 17′ thereof extend away from one another to form a support surface for the seat S, as shown in FIGS. 2 and 4. As shown in FIGS. 1 and 3-5, the two mating halves 14 and 15 can support separate end members 22 and 22′, which can be used to mount thereon an identification member, such as a license plate. Another means for attaching a separate end member 22a is illustrated in FIG. 3b. Alternatively, the legs 16 and 16′ of the mating halves 14 and 15 can also be provided with integral angled-off end members 22 and 22′, as shown in FIGS. 3a and 4a. Furthermore, the clamp member 12 is secured to the seat support member 11 via appropriate means 20, such as bolts. It should furthermore be noted that the holes in the components have been variously shown as round or square. Square holes are adapted to receive carriage head bolts, thus preventing turning of components relative to one another.

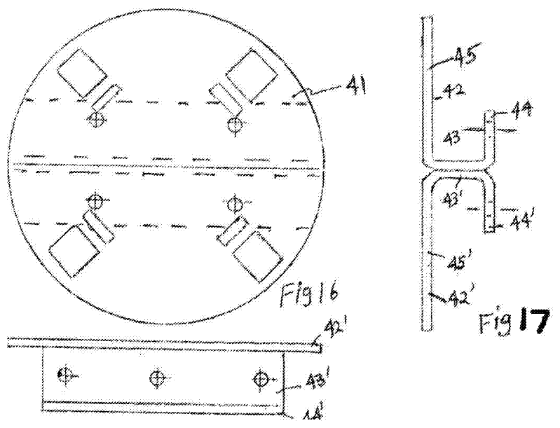

In place of the one-piece clamp member 12, a two-piece clamp member 12′ can be provided, which facilitates its use on any size of seat post. As shown in FIGS. 6a and 19, the clamp 12′ is again secured to the leg or legs of a seat support member 11 or 31/32 by bolts 20′. In addition, the nuts for securing together those ends of the two halves of the clamp 12′ remote from the leg or legs of the seat support member can be prevented from turning after tightening by having the ends of the clamp halves being bent, as shown at the arrow 12a in FIG. 6a.

The clamp member 12 is preferably adjustably mounted relative to the seat support member 11. This can be accomplished by providing at least one slot 23 (FIG. 3) in the legs 16 and 16′ of the mating halves 14 and 15 of the seat support member 11, and preferably a second slot 23a, so that when the clamp member 12 is secured to the seat support member 11, the angle of the clamp member 12 relative to the seat support member 11 can be adjusted using the slots 23 and 23a and appropriately tightening the securing means 20 (FIG. 2). In the alternative embodiment of FIG. 3a one slot 23 and a pivot hole 23′ are illustrated. Please note that the slots can also be square or rectangular.

A further embodiment for the adjustable mounting of the clamp member 12, 12′ to the seat support member 11, 31/32 is shown in FIGS. 20 and 21. To facilitate adjustment of the seat support member relative to the clamp member 12, gear bolts 20′ are used, which are secured, for example, by cap nuts 48. These gear bolts 20′ are provided with a geared section 47a that engages a cooperating gear rack 47b provided on the slots 23b of the support member. These gear racks 47b are expediently provided on the upper side of the slots 23b so that the weight exerted by a seated person provides a more positive engagement between the gear rack 47b and the geared section 47a. This gear bolt/gear rack arrangement can be used with any of the illustrated embodiments, and in particular for any of the illustrated holes or slots.

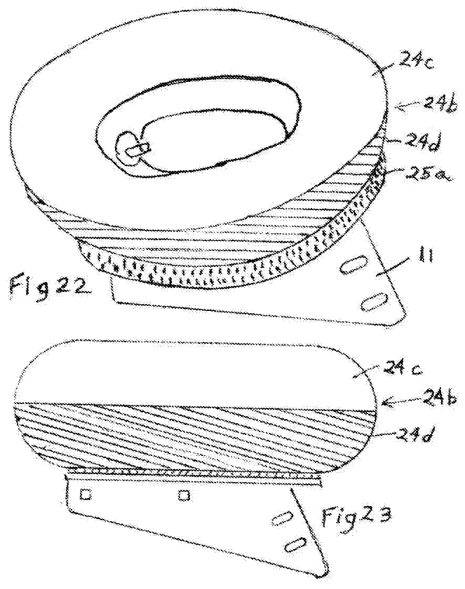

For maximum comfort, the seat S is preferably in the form of a somewhat compressible pneumatic cushion. In the illustrated embodiment the seat S is a pneumatic tube 24 (see also FIG. 7), such as a round, so-called donut, rubber tube. The hollow center of the pneumatic rubber tube helps to protect a rider's genitalia and provides additional orthopedic protection. This tube 24 can be secured to the seat support member 11 in any suitable manner. In the illustrated embodiment, straps, especially adjustable Velcro, i.e. hook and loop, straps, are utilized. For example, the straps 25 can extend around the tube 24, and can be secured to the seat support member 11, with the ends of each of the straps either being attached to one another, after extending from or through the seat support member 11, or one end of the strap can be attached to the seat support member and the other end can extend through a slot in the seat support member 11 and can attach to itself. The straps 25 can extend from or through the slots 26 in the seat support member 11, as shown by example in the embodiment illustrated in FIG. 4. See also the alternative embodiment illustrated in FIG. 8, with the straps extending through a slot prior to attachment to themselves. As shown in FIGS. 7 and 8, a cover 24a, such as a washable cloth or plastic cover, can also be provided for tube 24 of the seat S. Such a cover 24a can be provided in colors, and/or could be decorated, for example with logos, school colors, advertisements, etc., and could even be provided with one or more pockets, for example to accommodate a cell phone or a wallet. In FIG. 7, the straps 25 are shown attached to the cover 24a, while in FIG. 8 the straps 25 extend around the cover 24a of the seat tube 24. In the two-piece cover shown in FIGS. 22 and 23, the top portion 24c of the cover 24b, on which a person would sit, can be made of any desired material, while attached thereto is a lower portion 24d of Velcro loop material. Secured, e.g. by gluing, to the member 11 is velcro hook material 25a for seating thereon, in a strapless manner, the loop material of the lower portion 24d of the cover 24b.

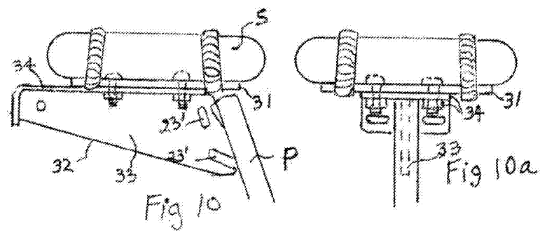

Pursuant to a second exemplary embodiment of the present invention, illustrated in FIGS. 3b and 8-11, the seat frame 30 is again comprised of three parts, in this case a one-piece disk member 31 to which the seat S can be secured in the manner described above. The disk member 31 can have the configuration described in conjunction with the previously described embodiment, or, for adjustable attachment of the disk member 31 to a second member 32 of the seat frame 30, can be provided with slots and/or holes as shown in FIGS. 8 and 11. The disk member 31 and the second member 32 when attached form a seat support member. The third part of the seat frame 30 is again a clamp member 12, here adjustably attached to the second member 32, for example as shown in FIG. 10.

In place of the two legs 16, 16′ and 17, 17′ of the two mating halves 14 and 15 respectively of the previously described embodiment, in this embodiment the second member 32 has a single leg 33, to which the clamp member 12 is attached (FIG. 9), again in the adjustable manner previously described. Integral with the single leg 33, for example by being welded thereto, is an elongated plate 34 that sits on, and extends at right angles from, both sides of the leg 33 for securement thereto of the disk member 31. To provide a license plate holder, the rear end of the elongated plate 34 can be bent down (FIG. 10). Alternatively, one of the means illustrated in FIG. 3, 3a, 4a or 3b can be utilized.

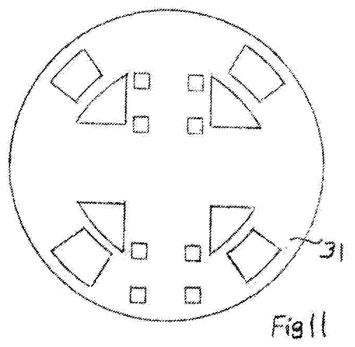

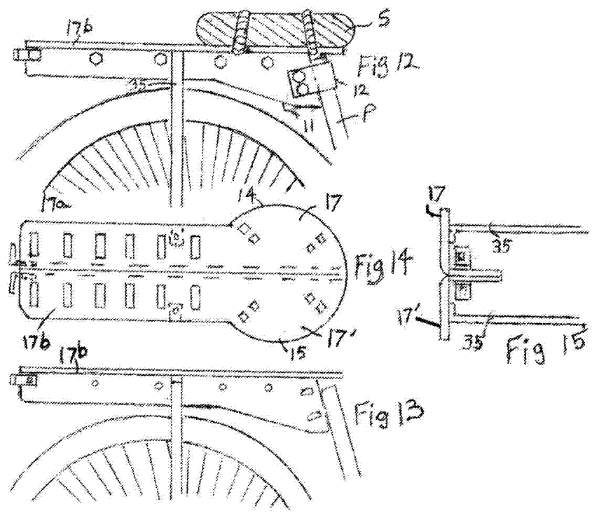

To provide a luggage rack or support for other objects, FIGS. 12-15 illustrate a further exemplary embodiment of the present invention. In particular, the ends of the two mating halves 14 and 15 of the seat support member 11 remote from the clamp member 12 are extended to provide a platform behind the seat S. This platform extension 17a, 17b can be provided with slots or other means to attach an object to the platform. Support legs 35 attached to the platform extension and extending to a rear wheel hub are preferably provided to help support the platform extension, especially when an object is secured to the latter. If desired, a second seat could be secured to the platform extension, as shown in FIG. 12a. Such a second seat could also be provided for the embodiment illustrated in FIGS. 16-18 and described below.

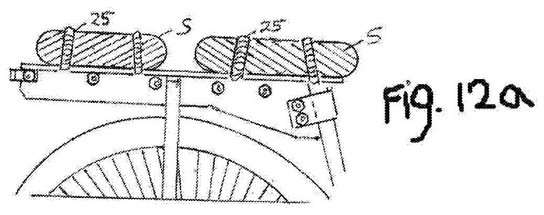

In the further exemplary embodiment shown in FIGS. 16-18, an alternative means of securement of the seat support member 41 to a surface other than a seat post, such as the elongated frame of a motorcycle or scooter, is illustrated. In particular, as a modification of the embodiment shown in FIGS. 1-5, in this embodiment the legs 44 and 44′ of the two mating halves 42 and 42′ of the seat support member 41 are bent away from one another, at right angles to the legs 43 and 43′, in a manner similar to the legs 45 and 45′ (see in particular FIG. 17). The legs 44 and 44′ can then be attached to the surface of the device on which a person can be seated.

It should be noted that the various seat support members can be machine-stamped from any type of metal, or can be molded from a variety of composite materials.

Although the seat frame of the present application has been described in conjunction with a bicycle seat, this seat frame can also be used, by way of example only, to support the seats of exercise machines, seats on boats, motorcycles and other means of transportation, or of any other device on which a person is to be seated.

The specification incorporates by reference the disclosure of provisional application Ser. No. 62/721,120.

The present invention is, of course, in no way restricted to the specific disclosure of the specification and drawings, but also encompasses any modifications within the scope of the appended claims.

I claim:

1. A seat frame, comprising:
a seat support member for supporting a seat; and
a clamp member, wherein the seat support member is adjustably mounted on said clamp member, and wherein the seat frame is mountable via the clamp member on a seat frame support of a device on which a person can be seated.

2. A seat frame according to claim 1, wherein said seat is a round pneumatic tube that is removably secured to said seat support member.

3. A seat frame according to claim 1, wherein seat support member is a two-part member.

4. A seat frame according to claim 3, wherein said seat support member comprises mating halves, each of which comprises two legs that are bent at right angles relative to one another.

5. A seat frame according to claim 4, wherein when said mating halves are placed together, respective legs of each extend away from one another and form a round disk for supporting said seat.

6. A seat frame according to claim 3, wherein said seat support member comprises a disk support member for supporting said seat, and a second member for supporting said disk member, wherein said second member is adjustably mounted on said clamp member.

7. A seat frame according to claim 6, wherein said second member is in the form of a single leg that is either integral with said disk member, or has a plate that extends perpendicular to said leg for supporting said disk member.

8. A seat frame according to claim 1, wherein said clamp member is a single piece that is adapted to extend around a seat frame support, and wherein said clamp member has two legs that are adapted to be mounted on said seat support member.

9. A seat frame according to claim 1, wherein said clamp member is a two-piece member that is adapted to extend around a seat frame support, wherein each piece has a first leg extending away from said seat support member, further wherein said first legs are adapted to be connected to one another, further wherein each piece has a second leg, and wherein said second legs are adapted to be mounted on said seat support member.

10. A seat frame according to claim 1, wherein said adjustable mounting of said seat support member on said clamp member is accomplished by providing at least one slot in said seat support member, and wherein said clamp member is provided with legs that are attached to said seat support member via said at least one slot.

11. A seat frame according to claim 10, wherein said at least one slot is provided with a gear rack for receiving a cooperating gear bolt via which said adjustable mounting of said seat support member on said clamp member is effected.

12. A seat frame according to claim 1, wherein an end of said seat support member remote from said clamp member is provided with end members for attachment of an identification device.

13. A seat frame according to claim 2, wherein said tube is secured to said seat support member via hook and loop straps.

14. A seat frame according to claim 5, wherein respective legs of said mating halves that face one another are secured to one another and support said clamp member.

15. A seat frame according to claim 5, wherein said mating halves are each provided with further legs that are also bent at right angles relative to one another, and wherein said further legs form said clamp member.

16. A seat frame according to claim 1, wherein said seat support member is provided with a support extension, such as for goods and/or an additional seat.

17. A seat frame according to claim 2, wherein a cover is provided for said tube.

18. A seat frame according to claim 17, wherein said cover is adapted to be secured to said seat support member in a strapless manner.

19. A method of mounting the seat frame of claim 1 on a seat frame support of a device, comprising:
placing said clamp member on or about the seat frame support of the device on which a person can be seated;
adjustably mounting said seat support member on said clamp member; and
securing a seat on said seat support member.
